(19) United States
(12) Patent Application Publication
(10) Pub. No.: US 2009/0256038 A1
(43) Pub. Date: Oct. 15, 2009

(54) Tethering Device For a Cup

(76) Inventor: Sarah Schaefer, Poplar Grove, IL (US)

Correspondence Address: BANNER & WITCOFF, LTD., TEN SOUTH WACKER DRIVE, SUITE 3000, CHICAGO, IL, 60606, US

(21) Appl. No.: 12/422,062

(22) Filed: Apr. 10, 2009

Related U.S. Application Data
(60) Provisional application No. 61/123,659, filed on Apr. 10, 2008.

(51) Int. Cl. A47G 23/02; F16B 47/00; B65D 25/00

(52) U.S. Cl. 248/206.2; 248/311.2; 220/737

(57) ABSTRACT

The present invention provides a beverage cup holder formed of a tether body having a proximal end, a distal end and an elongated body. The proximal end has an elastic band configured to receive a portion of a cup and the distal end has an attachment portion configured to releasably secure the tether body to a surface of an object. The elongated body further has a cord segment with a first portion adjacent the proximal end and a generally straight length of cord, and a second portion adjacent the distal end having a coiled length of cord that is configured to distort to an extended cord length when subject to stretching force.

### CROSS REFERENCE TO RELATED APPLICATIONS

This application claims priority to and the benefit of U.S. Provisional Application Ser. No. 61/123,659, filed Apr. 10, 2008, entitled “Infant/Toddler Cup Bungee,” which is incorporated herein by reference and made part hereof.

### TECHNICAL FIELD

The present invention relates to beverage cup support devices and, more specifically, relates to a tethering device for securing a cup to a surface near the user, typically a child, to keep the cup in reach, assist with handling the cup, and prevent the cup from landing on the ground.

### BACKGROUND

The present invention answers a need that exists for a usable and reliable device for securing a cup in proximity to a user, such as an infant, toddler or person with special needs. Typically, cups that are provided to such users are designed with special spill-resistant characteristics, such as a mouth spout, small opening for drink flow, and even internal valves to prevent flow of the fluid when the cup is tipped, such as when it falls on its side. Carriers or holders for such cups or baby bottles are sometimes used, typically consisting of a receptacle that is attached to a stroller handle or the arm of a chair, for insertion of the cup or bottle into the receptacle. An example of this type of cup holder is shown in U.S. Pat. No. 5,967,345, issued to Subotin (the '345 patent). The '345 patent discloses a baby bottle holder having a strap that is equipped with hook-loop fasteners to secure the holder to an object by wrapping the strap around the object and mating the two portions of the strap together with the hook-loop structure. Other devices for holing a cup adjacent a user include that which is disclosed in U.S. Pat. No. 7,090,183, which discloses, amongst other things, the use of a strap mounting device that is connected to a “fork” of the beverage holder to allow the holder to be mounted to many different bodies or apparatus.

Other devices have addressed the desire to have a cup secured directly to or immediately adjacent a user's body. Examples of these include U.S. Pat. No. 6,260,731, whereby the lid of the cup includes a clip for attaching the cup to one's waist band or belt. Another example is disclosed in U.S. Pat. Nos. 5,913,463; 7,275,668; and, 6,055,667. Each of these patents disclose different embodiments of devices that are used to secure a cup holder to a user, such that a cup, bottle or beverage container may be removably inserted or otherwise secured to the user. For example, FIG. 8 of U.S. Pat. No. 6,055,667 shows an infant feeding bib whereby a cup or bottle is held in place on the bib by a strap. Further, U.S. Pat. No. 5,913,463 shows and describes a cup holder that is molded to fit snugly against the user's chest and has a neck cord for the user to use to carry the cup holder.

Although such devices used for holding cups or beverage containers are useful for certain situations, and sometimes useful for assisting a child or baby or person with special needs, these devices do not provide the ability to freely allow use of a cup without concern that the cup may be lost, damaged or contaminated, such as when dropped on the ground during use. Further, prior art devices in general do not provide a preferred combination of usability by a child or toddler grasping the cup with adequate securement of the cup to a high chair or stroller surface. As a child or other user of a cup desires to freely grasp and move the cup, it is desirous to have a tether device that permits free and unrestricted use of a cup, yet still provide a secure and reliable structure for maintaining the cup in proximity of the user/child. The present invention answers this need and provides other useful benefits for a user of a cup and for caretakers assisting a child, toddler or person of special needs when drinking from a cup.

### BRIEF SUMMARY

It is an object of the present invention to provide a beverage cup holder formed of a tether body having a proximal end, a distal end and an elongated body. The proximal end has an elastic band configured to receive a portion of a cup and the distal end has an attachment portion configured to releasably secure the tether body to a surface of an object. The elongated body further has a cord segment with a first portion adjacent the proximal end and a generally straight length of cord, and a second portion adjacent the distal end having a coiled length of cord that is configured to distort to an extended cord length when subject to stretching force.

It is also an object of the present invention to provide a device for securing a beverage container to an object or surface, including a tether that has a proximal end and a distal end separated by an elongated body that has a flexible cord. The flexible cord includes a first portion that is adjacent the proximal end and a second portion located adjacent the distal end of the tether body. A band of material is connected to the first portion of the cord, and at least a portion of the cord is in a coiled arrangement with an expandable configuration with structural integrity to return to a coiled arrangement when not subject to a stretching force.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

To understand the present invention, it will now be described by way of example, with reference to the accompanying drawings in which:

FIG. 1 is an elevated perspective view of the tethering device for a beverage cup, shown secured to a typical child's cup, made in accordance with an embodiment of the present invention;

FIG. 2 is an elevated perspective view of the tethering device for a cup made in accordance with the teachings of the present invention;

FIG. 3 is a top plan view of the device shown in FIG. 2;

FIG. 4 is a detailed view of the connection between a tethering cord and an elastic band of the device shown in FIG. 2; and,

FIG. 5 is a partial end view of the device shown in FIG. 2, depicting detail of an attachment portion of the device, here shown as a suction cup.

### DETAILED DESCRIPTION

While this invention is susceptible of embodiments in many different forms, there are shown in the drawings and will herein be described in detail preferred embodiments of the invention with the understanding that the present disclosure is to be considered as an exemplification of the principles of the invention and is not intended to limit the broad aspect of the invention to the embodiments illustrated.

According to a preferred embodiment of the present invention, a beverage cup holder 10 is useful to secure a cup 11 to an object 13, such as a top tray of a child highchair, or a side portion of an infant car seat (not shown). The cup holder 10 has a tether body 12 with a proximal end 14, a distal end 16, and an elongated body 18. The proximal end 14 of the holder 10 has a band of material 20, preferably formed of an elastic material such as a polymer and, most preferably, formed from a silicone polymer. The band of material 20, or elastic band, is configured with an elastic structure to receive an outer dimension of at least a portion of a typical cup 11 to thereby secure the band 20 in position on the cup 11. The elastic band 20 is preferably formed as a continuous loop of the material, such that the band 20 may be stretched or deformed for it resting state of an inherent diameter to a larger diameter for stretching the band 20 to fit onto the cup 11. This configuration of the elastic band 20 forms a gripping or friction fit onto the outer surface of the cup 11 to hold the band 20 in place. This configuration also allows for repeated attachment and removal of the band 20 from the cup 11. To achieve this configuration and arrangement for attachment to a cup, the band 20, when formed of an elastic polymer, is preferably formed as a generally round continuous loop of material that is in the range of approximately two (2) to three (3) inches in diameter.

At the distal end 16 of the tether body 12, an attachment portion 22 is configured to releasably secure the tether body 12 to a surface of an object 13 that is positioned adjacent the tether body 12. In other words, the attachment portion 22 includes a fastener mechanism for securing the tether body 12 to an object 13 in such a way as to repeatedly attach and remove the tether body 12 from such connection. In a preferred embodiment, the attachment portion has an extending body 24 with an exposed aperture 26 that is configured to receive a portion of another part of the tether body 12. More specifically, the aperture 26 is configured to receive an end 28 of the cord segment 30 of the tether body 12. In the preferred embodiment shown in the Figures, the attachment portion or attachment body 22 includes a suction cup that is configured to attach to a surface of an object 13. In another embodiment, the attachment portion 22 may include a ring structure, such as an open loop or ring of polymer materials (not shown). This type of an attachment portion utilizing a ring of material, such as a plastic C-shaped ring, may be used to secure the body 12 to an object without the use of a suction cup.

The elongated body 18 preferably includes a length of cord material that forms a cord segment 30. A first portion 32 of the cord is located adjacent the proximal end 14 of the tether body 12, and preferably has an extent of generally straight cord 34. In the preferred embodiment, the generally straight portion 34 of the cord segment 30 is in the range of approximately three (3) to six (6) inches long. This length of the generally straight segment of the cord is preferred as a suitable amount of cord that is unlikely to kink or otherwise get in the way of a user drinking from the cup, such as a child grasping the cup to drink. Further, it has been found that this preferred range of the extent of generally straight cord 34 minimizes the likelihood that the cup will be pulled down as it sits in its proper place for use, such as sitting on an upper surface of a high-chair tray, as depicted in FIG. 1.

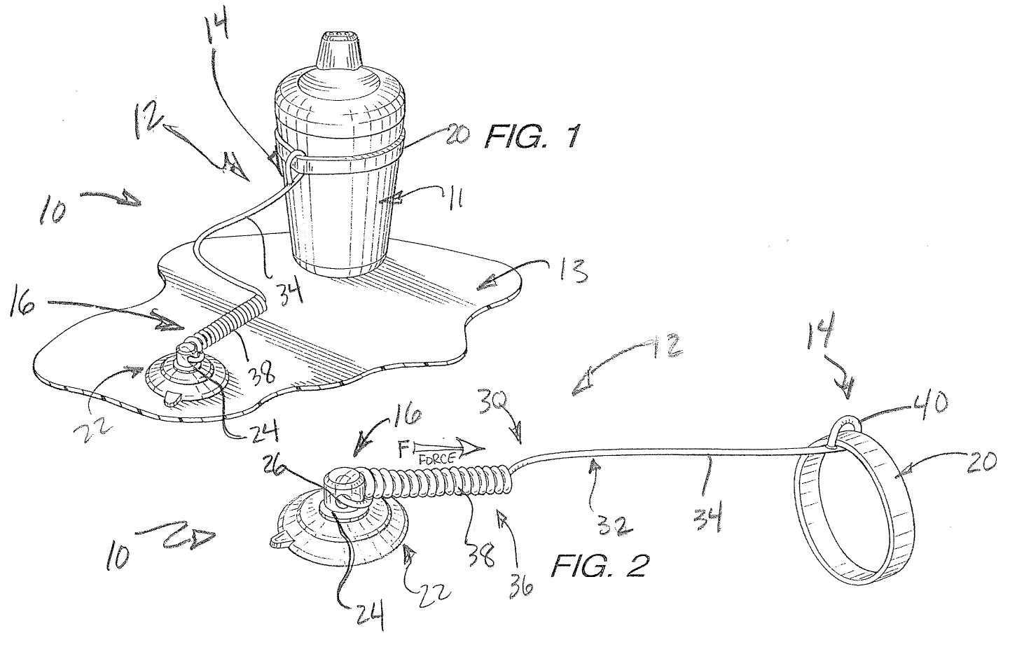

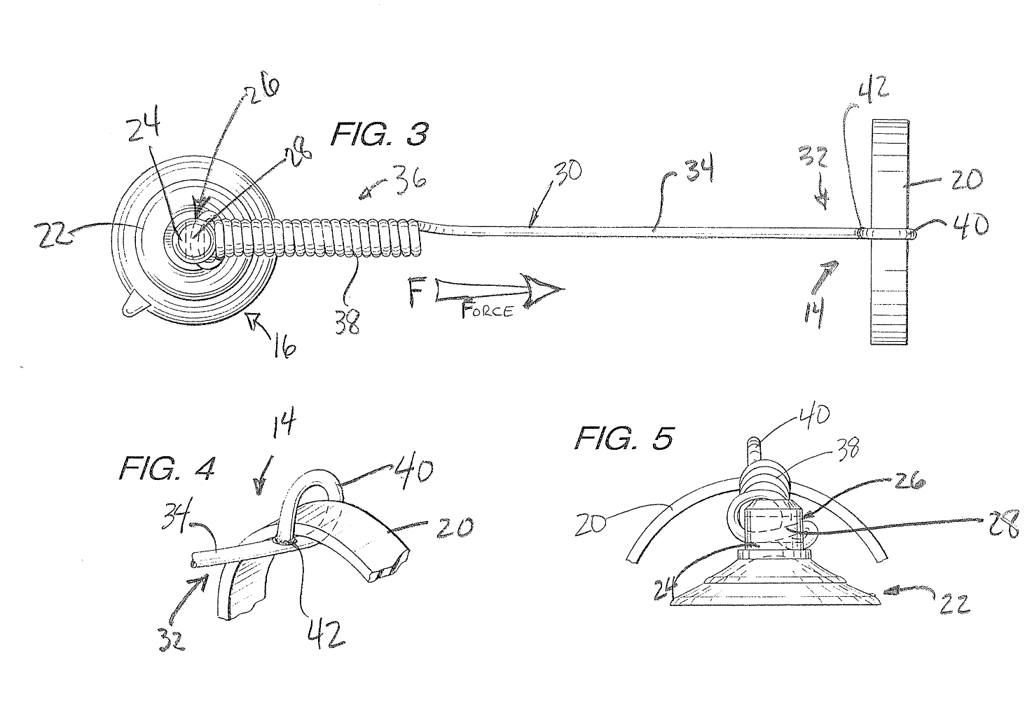

The cord segment 30 also has a second portion 36 that is located adjacent the distal end 16 of the body 12. The second portion 36 of the cord segment 30 preferably has an extent of coiled cord 38. The coiled length of cord 38 is configured to retain its coiled shape when no stretching force (F of FIGS. 2 and 3) is applied but is capable of resiliently distorting to an extended cord length when subject to stretching force. This aspect of the invention is significant to absorb the gravitational force when the cup is accidentally dropped, and subsequently returned to its retracted coiled state to remain out of the user's way when drinking from the cup. In the preferred embodiment, the extent of coiled cord 38 has a length in the range of approximately two (2) to four (4) inches when not stretched and is retracted to its tight coil state, as shown in the Figures. Thus, when not in the stretched state, the coiled cord segment 38 is short enough to be out of the way and to not coil back on itself to potentially tangle and thereby become useless for absorbing the shock of the cup falling. Further, this length of the coiled segment 38 provides ample shock absorption when a cup is dropped, to prevent or reduce the likelihood of disengaging the attachment portion 22 from the object 13, such as removal of the suction cup from a high chair tray when the force (F) stretches the cord coil.

The cord segment 30 is preferably attached to both the elastic band 20 and the attachment portion 22 or attachment body. In the preferred embodiment, the cord segment 30 has a loop 40 that secures the elastic band 20 by capturing or surrounding a portion of the band 20. This is best shown in FIGS. 2 and 4, wherein a lop 40 of the first end of the cord body 30 at the proximal end 14 of the device 12 is formed to capture the elastic band 20. In the embodiment shown, the loop 40 is formed by bending the cord back on itself and forming a bond, such as a melted junction of weld 42 to close the loop with the band 20 within the loop 40. At the other end of the tether body 12, the distal end 16 of the cord segment 30 is secured to the attachment portion or attachment member 22. This is preferably done by threading an extent of the end of the cord segment 30 into the aperture 26, such that a terminal segment 28 of the cord 30 is retained within the aperture 26. As is shown in FIGS. 3 and 5, the preferred structure of this attachment is by a closed loop that is formed by simply bending back a portion of the cord segment 30 onto itself after threading the end 28 through the aperture 26, then joining the cord by a melted union or weld, similar to the other end described and shown herein.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is further understood that the invention may be in other specific forms without departing from the spirit or central characteristics thereof. The present examples therefore are to be considered in all respects as illustrative and not restrictive, and the invention is not to be limited to the details given herein. Accordingly, while the specific examples have been illustrated and described, numerous modifications come to mind without significantly departing from the spirit of the invention and the scope of protection is only limited by the scope of the accompanying claims.

It should be appreciated that the preferred embodiment of the cup holder 10 is formed entirely of polymer material, such that it is easily washed after use and does not utilize fabric that may become soiled or stained by food or beverage that is typically present when using a beverage container. Thus, in the preferred form of the invention, the holder 10 is formed of at least two pieces: a silicone polymer band 20 and a continuous cord segment 30 that is secured to the band 20 and includes a coiled length 38 of the cord.

Also, it is preferable for the cord segment 30 to have a generally straight portion 34 that is adjacent the band 20, reducing obstruction to the user when grasping the cup connected to the holder 10.

The unified construction of the cord 30 made of plastic polymer and the band 20 made of silicone material is optimal for repeated use and cleaning. The coiled length 38 of the cord segment 30 is preferably formed as a tightly-coiled pliable plastic that has an ability to strength at least twice its coiled length when a stretching force is applied, and then retract back to the original coiled configuration, as shown in the Figures. Thus, the coil forms a spring arrangement to connect the cup to the intended object, and helps to absorb the shock of the force (F) of the cup falling from its intended place.

What is claimed is:

1. A beverage cup holder, comprising:
a tether body having a proximal end and a distal end and an elongated body, the proximal end having an elastic band configured to receive a portion of a cup to thereby secure the band in position, and the distal end of the tether body having an attachment portion configured to releasably secure the tether body to a surface separate of the tether body; and,
said elongated body comprising a cord segment with a first portion adjacent said proximal end having a generally straight length of cord and said cord segment having a second portion adjacent said distal end, said second portion having a coiled length of cord, said coiled length of coil being configured to distort to an extended cord length when subject to stretching force.

2. The cup holder of claim 1, wherein said elastic band comprises a substantially closed loop of elastic material with an inner dimension and configured to stretch to a larger inner dimension to receive a portion of a cup and thereby secure the elastic band in position.

3. The cup holder of claim 2, wherein said elastic band is at least partially made of a silicone polymer.

4. The cup holder of claim 1, wherein said cord segment comprises a continuous length of plastic cord with a first end secured to said elastic band and a second end secured to said attachment portion.

5. The cup holder of claim 4, wherein said plastic cord is secured to said elastic band with a loop surrounding a portion of the band.

6. The cup holder of claim 4, wherein said plastic cord is secured to said attachment portion with a loop passing into a portion of the attachment portion.

7. The cup holder of claim 4, wherein said attachment body has an aperture and said plastic cord passes through said aperture to secure the cord to said attachment portion.

8. The cup holder of claim 1, wherein said attachment portion includes a suction cup, said suction cup having an extending body with an aperture, and wherein an end of said elongated body extends into the aperture to at least partially secure the elongated body to the suction cup.

9. The cup holder of claim 1, wherein the elongated body is formed of a single length of plastic cord having a first end secured to the attachment portion and an expandable coiled segment adjacent the attachment portion.

10. The cup holder of claim 9, wherein the plastic cord has a second end secured to the elastic band by a closed loop of the cord passing through the elastic band and wherein the generally straight length of cord is adjacent said closed loop.

11. A device for securing a beverage container to an object or surface, comprising:
a tether with a proximal end and a distal end separated by an elongated body comprised of a flexible cord, said flexible cord having a first portion adjacent the proximal end and a second portion adjacent the distal end of the tether body; and,
a band of material positioned at the proximal end is connected to said first portion of the cord, wherein at least a portion of the cord is in a coiled arrangement with an expandable configuration with structural integrity to return to a coiled arrangement when not subject to a stretching force.

12. The device of claim 11, wherein the band of material is a closed loop of elastic material.

13. The device of claim 12 wherein the closed loop of elastic material is formed of a silicone polymer having a diameter between 2 and 3 inches.

14. The device of claim 1, wherein the portion of the cord having a coiled arrangement has a length in the range of approximately 2 to 4 inches.

15. The device of claim 11 wherein the elongated body includes a generally straight segment of cord extending between said coiled arrangement and said band of material positioned at the proximal end of the tether.

16. The device of claim 15, wherein the generally straight segment of cord has a length of approximately 3 to 6 inches.

17. The device of claim 11, wherein an attachment body is secured to the distal end of the tether, the attachment body being configured to releasably secure the tether to an object.

18. The device of claim 17, wherein the attachment body comprised a suction cup that is secured to the cord.

19. The device of claim 17, wherein the attachment body includes a polymer ring.
